(19) United States
(12) Patent Application Publication
(10) Pub. No.: US 2003/0223042 A1
(43) Pub. Date: Dec. 4, 2003

(54) Method and apparatus for displaying motion pictures

(76) Inventor: Michael Ira Rudnick, San Francisco, CA (US)

Correspondence Address: Michael Ira Rudnick, 312 Texas Street, San Francisco, CA, 94107, US

(21) Appl. No.: 10/444,388

(22) Filed: May 27, 2003

Related U.S. Application Data
(60) Provisional application No. 60/384,018, filed on May 30, 2002.

(51) Int. Cl. G03B 25/00

(52) U.S. Cl. 352/101

(57) ABSTRACT

A method and apparatus for displaying motion pictures. In one embodiment, a cylindrical body with vertical facets ringed by a series of motion-picture images within or around the cylinder (that independently turn within or around the cylinder). When the images spin within or around the substantially fixed cylinder, to the viewer looking through the cylinder's faceted field, the background images pass (or “flip”) through two or more of the cylinder's facets, producing a “shutter-like” effect, such that each image is replaced by an adjacent one of the series of motion-picture images (to produce an animated effect).

### CROSS-REFERENCE TO RELATED APPLICATION

The present application claims the benefit of its prior provisional patent application No. 60/384,018, filed by Michael Rudnick on May 30, 2002 (confirmation #5220); note both applications represent the same invention by the same inventor.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

A. Field of Endeavor

The present invention relates generally to motion pictures and, more specifically, the present invention relates to devices and methods for viewing motion pictures.

B. Information Known by Inventor (on Related Art)

Typical animated picture technology commonly utilizes film or video/new media, each with associated costs and complexities (like from equipment, maintenance and performance needs). By eliminating these costs and complexities, animated images become more practical and attainable for low-cost novelty items (like zoetropes or praxinoscopes). Furthermore, the simplicity that these alternate methods of producing animated images have, allows for the creation of more simple and durable products (like Michael Rudnick's aeotrope, U.S. Pat. No. 5,760,874).

As can be appreciated by those skilled in the art, the zoetrope motion-picture display device had the disadvantage of limiting observation of the motion-picture images to the space of the zoetrope's slits, while the praxinoscope motion-picture display device has the disadvantage of needing mirrors. Consequently, Michael Rudnick invented his aeotrope, another motion-picture display device that does not employ the use of film or video/new media, nor the use of slits passing through a field of vision, nor the use of mirrors.

Rather, Michael Rudnick's aeotrope motion-picture display device includes a clear cylinder with facets spaced apart at periodic intervals. A series of motion-pictures are positioned on or near the cylinder, such that when the cylinder is rotated, the motion-picture images appear to be animated when viewed through the facets (thereby allowing for a broader range of observation, while avoiding the use of expensive materials).

However, as can be appreciated by one skilled in the art, Michael Rudnick's aeotrope has the disadvantage of requiring a faceted viewing-field to move along in unison with the series of images (because the images are positioned on or near to a particular facet). This limits positioning of the faceted viewing-field, and also limits the positioning or breadth of the imagery (to that which would move along in unison with a corresponding faceted viewing-field). Therefore, what is desired is a motion-picture display device that eliminates the need for film or video/new media equipment, allows a viewer to observe motion-picture images from a wide variety of viewing angles (without using mirrors), yet also has a faceted viewing-field that can be positioned independently of the moving series of motion-picture images.

### BRIEF SUMMARY OF THE INVENTION

A method and apparatus for displaying motion pictures is disclosed. In one embodiment, a cylindrical body with vertical facets ringed by a series of motion-picture images within or around the cylinder (that independently turn within or around the cylinder). When the images spin within or around the substantially fixed cylinder, to the viewer looking through the cylinder's faceted field, the background images pass (or “flip”) through two or more of the cylinder's facets, producing a “shutter-like” effect, such that each image is replaced by an adjacent one of the series of motion-picture images (to produce an animated effect).

Note this method and apparatus for displaying motion-pictures eliminates the need for film or video/new media equipment, allows a viewer to observe motion-picture images from a wide variety of angles (without using mirrors), and has a faceted viewing field that can be positioned independently of the moving series of motion-picture images. This enables one to create, for example, a low-cost animation novelty (with new and improved qualities). Additional features and benefits of the present invention will become apparent from the detailed description, figures and claims set forth below.

### BRIEF DESCRIPTION OF THE SEVERAL VIEWS OF THE DRAWING

The present invention is illustrated by way of example and not limitation in the accompanying figures.

FIG. 1A is a perspective view of a motion-picture display device with a rotatable base or top in accordance with the teachings of this invention.

FIG. 1B is a top view of a motion-picture display device in FIG. 1A, in accordance with the teachings of the present invention.

FIG. 2A is a perspective view of a motion-picture display device resembling a spyglass, with only two facets, through which one views a series of motion-picture images that pass by (including, for example, from a reel of film, flock of live birds, or stream of highway-traffic).

### DETAILED DESCRIPTION OF THE INVENTION

A method and an apparatus for displaying motion pictures is disclosed. In the following description, numerous specific details are set forth in order to provide a thorough understanding of the present invention. It will be apparent, however, to one having ordinary skill in the art, that the specific detail need not be employed to practice this invention. In other instances, well-known materials or methods have not been described in order to avoid obscuring the present invention.

The present invention provides a method and an apparatus for displaying motion-pictures by providing a cylindrical body (the “viewing field”), with facets that align perpendicularly to any series of moving-picture images that pass behind this faceted viewing-field, which when viewed produces an animated effect. The present invention allows for a cylindrical body with facets ringed by a series of motion-picture images within or around the cylinder (that independently turn within or around the cylinder). When the images spin within or around the substantially fixed cylinder, to the viewer looking through the cylinder's faceted field, the background images pass (or “flip”) through one or more of the cylinder's facets, producing a “shutter-like” effect, such that each image is replaced by an adjacent one of the series of motion-picture images (to produce an animated effect).

The present invention also allows for a lens (or viewing-field), with two or more facets aligned against a series of motion-picture images (as from a reel of film, flock of live birds, or stream of highway-traffic). When the images move or run behind the lens, to the viewer looking through the lens' faceted viewing-field, these background images pass (or “flip”) through the two or more facets, producing a “shutter-like” effect, such that each image is replaced by an adjacent one of the series of motion-pictures images (to produce an animated effect).

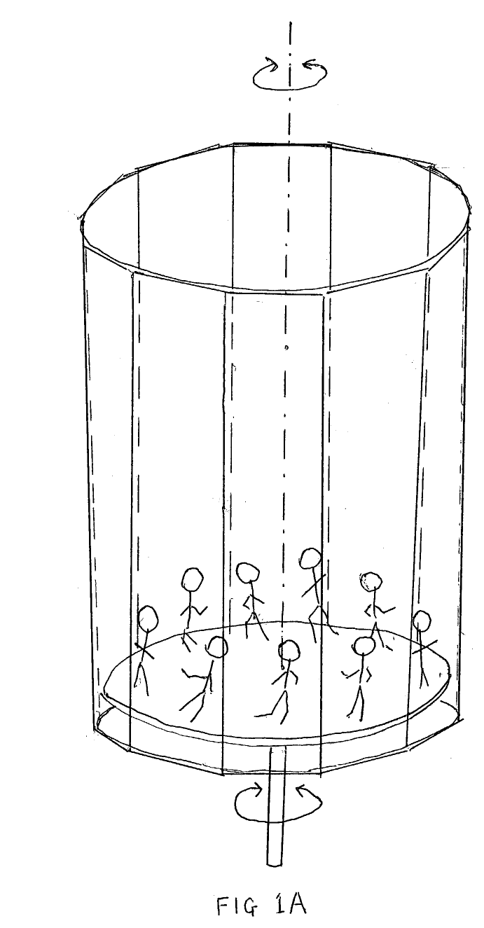

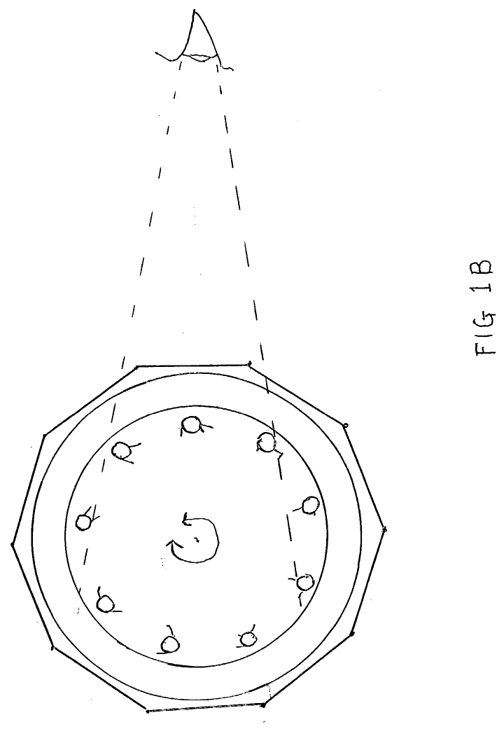

FIG. 1A shows a perspective of the presently best-contemplated mode for the present invention, that includes a cylindrical body with vertical facets, and a ring of motion-picture figures disposed within the cylinder (and in a series). In this embodiment, the figures are set on a disc that is made to be rotated independently of the cylinder, about its longitudinal axis (from the top or bottom, and with or without mechanization), and creating a series. To the viewer looking through the substantially fixed faceted cylindrical viewing-field, as the series of images pass by in rotation, these background images pass (or “flip”) through the cylinder's facets, producing a “shutter-like” effect, such that each image is replaced by an adjacent one of the series of motion-pictures images (to produce an animated effect)

FIG. 1B shows a top view of the same embodiment shown in FIG. 1A.

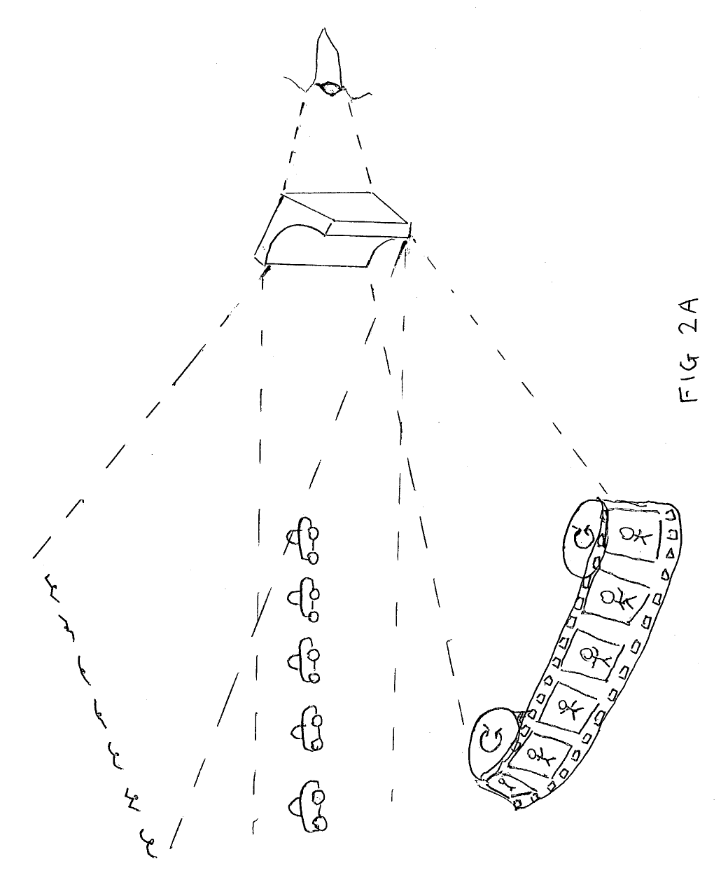

FIG. 2A shows a perspective view of another embodiment of the present invention, that includes a lens (or viewing-field), with two facets aligned against a series of motion-picture images (as from a reel of film, flock of live birds, or stream of highway-traffic). When the images move behind the lens, to the viewer looking through the lens, these background images pass (or “flip”) through the two facets, producing a “shutter-like” effect, such that such that each image is replaced by an adjacent one of the series of motion-pictures images (to produce an animated effect).

Thus, what has been described is a method and apparatus for displaying a motion picture. With the presently described motion-picture display device, motion pictures can be displayed without the use of film or video/new media equipment, thereby avoiding the costs and complexities associated with them. Further, the present invention allows for a wide variety of motion-picture images or figures to be used, which can then be appreciated from a broad range of speeds, angles, distances or lighting conditions (and without the use of mirrors, but with a faceted viewing-field that can be positioned independently of the moving series of motion-picture images).

In the foregoing detailed description, the method and apparatus of the present invention has been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

What is claimed as my invention is:

1. A motion picture display device, comprising:
a faceted body, wherein the facets are substantially clear and visible to an onlooker (such as facets on a cylinder, prism or lens); and
a series of motion-picture images, wherein each one of the series of motion-picture images is substantially visible to an onlooker; and
wherein the series of motion-picture images moves independently of the faceted-body, and are thus seen to pass or “flip” through the facets (producing a “shutter-like” effect), such that each image is replaced by an adjacent one of the series of motion-picture images (to produce an animated effect).

2. The motion picture display device described in claim 1, wherein the series of images are 2 dimensional.

3. The motion picture display device described in claim 1, wherein the series of images are 3 dimensional.

4. The motion picture display device described in claim 1, wherein the series of images are within the faceted body (for example, as with a ring of figures that turns within a faceted-cylinder).

5. The motion picture display device described in claim 1, wherein the series of images are outside of the faceted body (for example, as with a ring of figures that turns outside of a faceted-cylinder).

6. The motion picture display device described in claim 1, wherein the series of images are independent of the faceted body (for example, as with a flock of live birds seen moving through a faceted spyglass).

7. The motion picture display device described in claim 1, wherein the faceted body has only 2 facets.

8. The motion picture display device described in claim 1, wherein the faceted body has more than 2 facets.

9. A method for viewing motion pictures, comprising the steps of:
providing a faceted body, wherein the facets are substantially clear and visible to an onlooker (such as facets on a cylinder, prism or lens); and
disposing a series of motion-picture images, wherein each one of the series of motion-picture images is substantially visible to an onlooker looking through the faceted body; and
wherein the series of motion-picture images moves or are made to move independently of the faceted-body, and are thus seen to pass or “flip” through the facets (producing a “shutter-like” effect), such that each image is replaced by an adjacent one of the series of motion-picture images (to produce an animated effect).

10. The method described in claim 9, wherein the series of images are 2 dimensional.

11. The method described in claim 9, wherein the series of images are 3 dimensional.

12. The method described in claim 9, wherein the series of images are within the faceted body (for example, as with a ring of figures that turns within a faceted-cylinder).

13. The method described in claim 9, wherein the series of images are outside of the faceted body (for example, as with a ring of figures that turns outside of a faceted-cylinder).

14. The method described in claim 9, wherein the series of images are independent of the faceted body (for example, as with a flock of live birds seen moving through a faceted spyglass).

15. The method described in claim 9, wherein the faceted body has only 2 facets.

16. The method described in claim 9, wherein the faceted body has more than 2 facets.
